(19) United States
(12) Patent Application Publication
(10) Pub. No.: US 2026/0260570 A1
(43) Pub. Date: Sep. 3, 2026

(54) METHOD FOR URBAN ULTRA-LOW ALTITUDE AIRSPACE DIVISION AND CAPACITY CALCULATION

(71) Applicant: Civil Aviation Flight University of China, Guanghan (CN)

(72) Inventors: Weijun Pan, Guanghan (CN); Jianwei Gao, Guanghan (CN); Xuan Wang, Guanghan (CN); Qinghai Zuo, Guanghan (CN); Tian Luan, Guanghan (CN); Rundong Wang, Guanghan (CN); Qinyue He, Guanghan (CN)

(21) Appl. No.: 19/009,918

(22) Filed: Jan. 4, 2025

(30) Foreign Application Priority Data
Jul. 10, 2024 (CN) 2024109230731

(51) Int. Cl. G08G 5/52; G08G 5/27; G08G 5/54; G08G 5/76

(52) U.S. Cl. CPC G08G 5/52; G08G 5/27; G08G 5/54; G08G 5/76

(57) ABSTRACT

A method for urban ultra-low altitude airspace division and capacity calculation includes steps as follows. An improved Voronoi method is used to divide airspace. A fundamental airspace capacity is calculated. Urban building information data is acquired to calculate a population exposure risk index, and a building impact factor. Micro-meteorological data and communication signal data of the urban buildings are acquired to calculate an average signal strength, a signal propagation path length, and a micro-scale meteorological impact factor. An airspace model is used to calculate the urban ultra-low altitude airspace capacity based on the fundamental airspace capacity, the population exposure risk index, the building impact factor, the average signal strength, the signal propagation path length, and the micro-scale meteorological impact factor. The method can quickly, efficiently, and accurately calculate the ultra-low altitude airspace capacity calculation using a small amount of data.

### TECHNICAL FIELD

The disclosure relates to the technical field of airspace management, and particularly to a method for urban ultra-low altitude airspace division and capacity calculation.

### BACKGROUND

The ultra-low altitude airspace in the disclosure refers to the airspace below the true altitude of 120 meters within flyable airspace. Currently, methods for calculating the capacity of the urban ultra-low altitude airspace mainly focus on simulation models, data-driven methods, optimization algorithms, and rule and constraint-based methods.

The method based on the simulation models includes constructing a simulation environment to simulate a flight of unmanned aerial vehicles (UAVs) of different quantities and types within a specific airspace, and assessing airspace capacity. The method based on the simulation models typically includes the following steps: (1) modeling: establishing a three-dimensional model of an urban ultra-low altitude airspace, considering factors such as buildings, obstacles, and meteorological conditions; (2) simulating flight: simulating the flight of UAVs within the urban ultra-low altitude airspace, analyzing flight paths, obstacle avoidance, and airspace utilization; (3) capacity assessment: evaluating the number of UAVs that can be accommodated within the urban ultra-low altitude airspace based on simulation results. The method uses various simulation platforms and tools, such as MATLAB, SUMO, AirSim, etc., for simulation studies.

A data-driven method relies on big data and machine learning technologies to predict the airspace capacity by analyzing a vast amount of UAV flight data. The data-driven method typically includes the following steps: (1) data collection and preprocessing: gathering UAV flight logs, meteorological data, urban building data, etc., and performing data cleaning and processing; (2) feature extraction: extracting key features from the data that affect the airspace capacity, such as flight altitude, speed, flight density, etc.; (3) model training: training a predictive model using machine learning algorithms (such as random forests, support vector machines, neural networks, etc.); (4) capacity forecasting: using the trained predictive model to forecast the airspace capacity. The advantage of the data-driven method is that it can leverage massive amounts of data for precise predictions, but it also requires a large volume of high-quality data and substantial computational power.

A method based on the optimization algorithms introduce a variety of intelligent optimization algorithms that can optimize the flight paths of the UAVs in complex urban environments, thereby improving airspace utilization efficiency. The optimization algorithms include: (1) genetic algorithms: simulating a process of natural selection, optimizing UAV flight paths through operations such as crossover and mutation; (2) particle swarm optimization: simulating foraging behavior of bird flocks, seeking the best flight path configuration through information sharing among individuals; (3) ant colony optimization: simulating a process of ants finding food, optimizing UAV path selection through the release and feedback of pheromones. The method based on the optimization algorithms can effectively handle multi-objective optimization problems in the airspace capacity calculations, enhancing the overall coordination and safety of the UAV flight.

The rule and constraint-based method primarily relies on established flight rules and airspace management strategies. It calculates the airspace capacity by analyzing the flight behavior of the UAVs under the rules and constraints. The rule and constraint-based method typically includes the following steps: (1) flight rule setting: formulating rules for the UAV flight altitude, speed, obstacle avoidance strategies, etc.; (2) constraint analysis: examining the impact of the rules and the constraints on UAV flight paths and airspace utilization; (3) capacity calculation: calculating the number of UAVs that can be accommodated within the airspace based on the established rules and constraints. The advantage of the rule and constraint-based method is its clear rules and ease of implementation, but it may lack flexibility when facing complex urban environments and variable flight requirements.

The above methods all require a large amount of historical flight data of the UAVs as support. Acquiring data is challenging, and model building is complex, which is not conducive to rapid assessment of the urban ultra-low altitude airspace capacity. Currently, there is a wealth of public literature on urban low-altitude airspace research, but less on the urban ultra-low altitude airspace. Compared to the urban low-altitude airspace, the urban ultra-low altitude airspace allows for lower flight heights, has a more complex airspace environment, and has a greater impact on the safety of pedestrians on the ground. Therefore, calculations of the capacity of urban ultra-low altitude airspace also require a method that can be fast, uses a small amount of data, and is efficient and accurate.

### SUMMARY

The purpose of the disclosure is to quickly, efficiently, and accurately calculate the ultra-low altitude airspace capacity using a small amount of data. Therefore, a method for urban ultra-low altitude airspace division and capacity calculation is provided

In order to achieve above purpose, the technical solutions of the disclosure are as follows.

A method for urban ultra-low altitude airspace division and capacity calculation includes steps as follows.
Step 1: an improved Voronoi method is used to divide airspace.
Step 2: a fundamental airspace capacity is calculated.
Step 3: urban building information data is acquired to calculate a population exposure risk index, and a building impact factor.
Step 4: micro-meteorological data and communication signal data of the urban buildings are acquired to calculate an average signal strength, a signal propagation path length, and a micro-scale meteorological impact factor.
Step 5: an airspace model is used to calculate the urban ultra-low altitude airspace capacity based on the fundamental airspace capacity, the population exposure risk index, the building impact factor, the average signal strength, the signal propagation path length, and the micro-scale meteorological impact factor.

Compared to the related art, the beneficial effects of the disclosure are as follows.

(1) The precise ultra-low altitude airspace capacity calculation. By comprehensively considering factors such as airspace area, a no-fly zone, and a service rate, it is possible to accurately calculate the ultra-low altitude airspace capacity for specific time periods, which provides data support for the formulation of reasonable aircraft flight plans, avoiding excessive airspace congestion, and improving airspace utilization efficiency.

(2) Ensuring aircraft flight safety. By calculating and adjusting a population density and population exposure risk, ensuring that aircraft flight paths avoid densely populated areas, reducing potential harm to ground personnel, and considering the height and distribution of buildings, which helps to avoid collisions between aircraft and buildings, further enhancing flight safety.

(3) Improving communication link signal levels. Considering the balance of signal strength and path length ensures the stability of communication and path optimization during aircraft flight, which is conducive to improving the success rate and efficiency of flight missions, and reducing flight interruptions or accidents caused by signal issues.

(4) Reducing airspace interference. By considering the interference of the buildings on the airspace, which optimizes the aircraft flight paths and communication facility layout, reduces signal shielding and interference, improves the stability and reliability of communication, and ensures the normal operation of aircraft in complex urban environments.

(5) Assessing meteorological conditions. By introducing micro-meteorological data, assessing the impact of meteorological factors such as wind speed, temperature, and humidity on flight, it is helpful to adjust the flight plans in time under different meteorological conditions, ensuring the safety and stability of the aircraft flight, and reducing accidents and mission failures caused by severe weather.

(6) Enhancing airspace management efficiency. By dividing the airspace using the improved Voronoi method and comprehensively calculating the ultra-low altitude airspace capacity, the efficiency of airspace management is improved.

### BRIEF DESCRIPTION OF DRAWINGS

To more clearly illustrate the technical solution of the embodiment of the disclosure, a brief introduction to the attached drawings required in the embodiment will be provided below. The attached drawings only show a certain embodiment of the disclosure, and therefore should not be construed as limiting the scope of the disclosure. For those skilled in the art, without the need for creative effort, other related drawings can also be obtained based on the attached drawings.

FIG. 1 illustrates a flowchart of a method in the disclosure.

FIG. 2 illustrates a schematic diagram of dividing airspace in the disclosure.

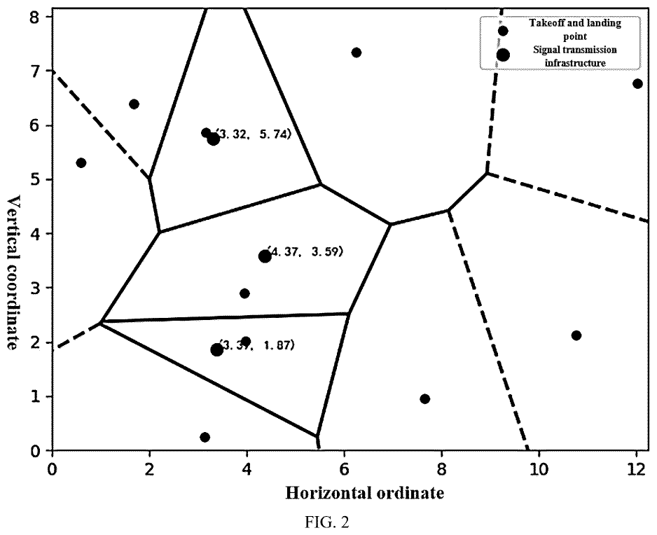

### DETAILED DESCRIPTION OF EMBODIMENTS

The following will combine the attached drawings in the embodiment of the disclosure to provide a clear and complete description of the technical solutions in the embodiment of the disclosure. It is evident that the described embodiment is only a part of the embodiments of the disclosure, not all of them. The components of the embodiment in the disclosure described and shown in the attached drawings here can be arranged and designed in various configurations. Therefore, the detailed description of the embodiment of the disclosure provided in the attached drawings is not intended to limit the scope of the disclosure, but merely to represent a selected embodiment of the disclosure. All other embodiments obtained by those skilled in the art without making creative efforts based on the embodiment of the disclosure fall within the scope of protection of the disclosure.

It should be noted that: similar reference numbers and letters in the attached drawings represent similar items. Therefore, once an item is defined in the attached drawing, it does not need to be further defined and explained in subsequent attached drawings. In addition, in the description of the disclosure, terms such as “first,” “second,” etc., are used only for descriptive purposes and should not be understood as indicating or implying relative importance, or suggesting that there is any such actual relationship or order between these entities or operations. Additionally, terms like “connect,” “link,” etc., can mean direct connections between components or indirect connections through other components.

The scope of the disclosure includes only micro, light, and small UAVs. The micro UAVs refer to those with an empty weight of less than 0.25 kilograms (kg), a maximum true flight altitude not exceeding 50 meters (m), a maximum horizontal flight speed not exceeding 40 kilometers per hour (km/h), radio transmission equipment that meets the technical requirements for micro-power short-distance communication, and can be manually intervened and controlled at any time during the entire flight. The light UAVs refer to those with an empty weight not exceeding 4 kg and a maximum takeoff weight not exceeding 7 kg, a maximum horizontal flight speed not exceeding 100 km/h, equipped with airspace maintenance capabilities and reliable surveillance capabilities that meet airspace management requirements, and can be manually intervened and controlled at any time during the entire flight, excluding the micro UAVs. The small UAVs refer to those with an empty weight not exceeding 15 kg and a maximum takeoff weight not exceeding 25 kg, equipped with airspace maintenance capabilities and reliable surveillance capabilities that meet airspace management requirements, and can be manually intervened and controlled at any time during the entire flight, excluding the micro and light UAVs.

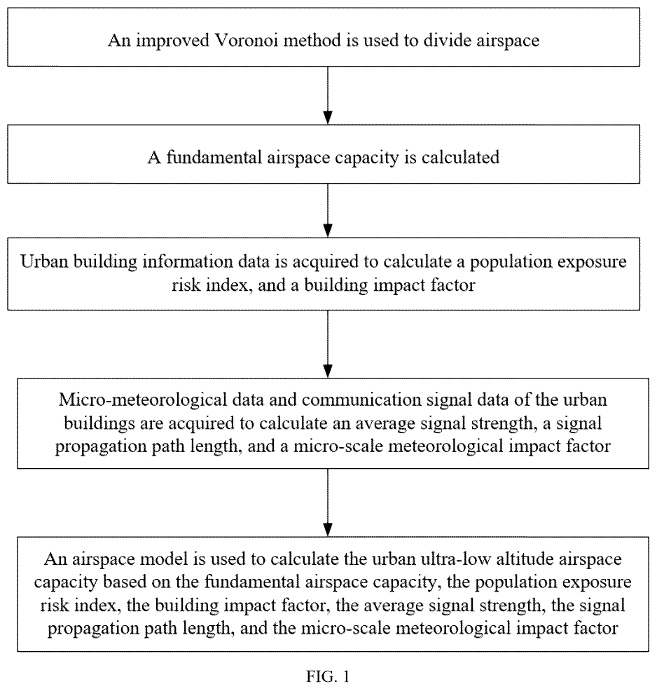

The disclosure is implemented through the following technical solution, as shown in FIG. 1, which is a method for urban ultra-low altitude airspace division and capacity calculation.

The method includes the following steps.

Step 1: an improved Voronoi method is used to divide airspace.

A Voronoi method is improved by adding dynamic balance weights thereto obtain the improved Voronoi method:

$$P = \{ {p}_{1} , {p}_{2} , … , {p}_{n} \} ;$$

$$W = \{ {w}_{1} , {w}_{2} , … , {w}_{n} \} ;$$

where n represents a number of sub-airspaces after the dividing, and there is only one takeoff and landing point in each of the sub-airspaces; P represents a set of the takeoff and landing points of the respective sub-airspaces, pᵢ represents an i-th takeoff and landing point; W represents a set of initial weights, wᵢ represents an initial weight of the i-th takeoff and landing point, and wᵢ=1, i=1, 2, . . . , n.

$${d}_{w} ( x , {p}_{i} ) = \sqrt{{( {x}_{1} - {p}_{i 1} )}^{2} + {( {x}_{2} - {p}_{i 2} )}^{2}} - {w}_{i} ;$$

Where d_{w}(x, pᵢ) represents a weighted distance. For any point x within the airspace, pᵢ minimizing d_{w}(x, pᵢ) is found to assign x to V(pᵢ).

Where V(pᵢ) represents an i-th sub-airspace where pᵢ is located; x₁ represents a horizontal coordinate of the point x, and x₂ represents a vertical coordinate of the point x; pᵢ₁ represents a horizontal coordinate of the takeoff and landing point pᵢ, and pᵢ₂ represents a vertical coordinate of the takeoff and landing point pᵢ.

$${A}_{i} = \int {V ( {p}_{i} )}^{dA} ;$$

$$\overline{A} = \frac{1}{n} {Σ}_{i = 1}^{n} {A}_{i} ;$$

$${f}_{i} = \frac{{A}_{i}}{\overline{A}} ;$$

$${w}_{i} ← {w}_{i} \cdot {f}_{i} ;$$

Where A represents a total area of the airspace; Aᵢ represents an area of the i-th sub-airspace; and

$$\overline{A}$$

represents an average area of the sub-airspaces; fᵢ represents a dynamic balance factor of the i-th sub-airspace; wᵢ←wᵢ·fᵢ represents fᵢ approaching 1 after several iterations, which indicates that a value of Aᵢ and a value of

$$\overline{A}$$

tend to be equal, making the area of each sub-airspace as uniform as possible.

The dynamic balance weights aim to dynamically adjust the weights of UAV takeoff and landing points to make area of the airspace divided by the improved Voronoi method tend to be uniform. The method is based on the basic principles of Voronoi diagrams and achieves the goal through iterative optimization.

Step 2: a fundamental airspace capacity is calculated.

The calculation of the fundamental airspace capacity is as follows:

$${C}_{b} = ( A - {A}_{nf} ) \cdot T \cdot μ ;$$

where C_{b} represents the fundamental airspace capacity, A represents the total area of the airspace, with a unit being square kilometers (km²); A_{nf} represents an area of a no-fly zone, with a unit being km²; T represents a time period, with a unit being hour (h); μ represents a service rate, with a unit being a flight per (h·km²).

$$μ = \frac{{n}^{2} ( {F}_{dm} + {F}_{dl} + {F}_{ds} )}{{Σ}_{i = 1}^{n} {D}_{a i}} ;$$

where F_{dm} represents a takeoff and landing frequency of a micro unmanned aerial vehicle (UAV), with a unit being a flights per h; F_{dl} represents a takeoff and landing frequency of a light UAV, with a unit being a flights per h; F_{ds} represents a takeoff and landing frequency of a small UAV, with a unit being a flights per h; Dₐᵢ represents an average distance from the i-th takeoff and landing point pᵢ to boundary vertices of the i-th sub-airspace of pᵢ, with a unit being km.

$${D}_{a i} = \frac{1}{K} {Σ}_{k = 1}^{K} \sqrt{{( {x}_{k} - {p}_{i 1} )}^{2} + {( {y}_{k} - {p}_{i 2} )}^{2}} ;$$

where K represents a number of the boundary vertices of the i-th sub-airspace, typically, boundary points of the sub-airspace include the boundary vertices, for example, when boundary lines of the sub-airspace form a quadrilateral, then K=4, and k=1, 2, . . . , k; xₖ represents a horizontal coordinate of a k-th boundary vertex, and yₖ represents a vertical coordinate of the k-th boundary vertex.

Based on urban planning departments, remote sensing imagery, LiDAR point cloud data, etc., the total airspace area and the no-fly zone area are considered to calculate the fundamental airspace capacity for a given time period.

Step 3: urban building information data is acquired to calculate a population exposure risk index, and a building impact factor.

The urban building information data is obtained from open-source data websites or platforms, and the population exposure risk index is calculated based on the defined urban ultra-low altitude airspace scope.

The calculation of a population exposure risk index is as follows:

$$PERI = \frac{1}{n} {\sum }_{i = 1}^{n} {O}_{i} \cdot {R}_{i} ;$$

$${PERI}_{max} = max \{ {O}_{1} \cdot {R}_{1} , {O}_{2} \cdot {R}_{2} , … , {O}_{n} \cdot {R}_{n} \} ;$$

where divided urban regions are corresponding to the divided sub-airspaces of the airspace; PERI represents the population exposure risk index, and PERIₘₐₓ represents a maximum value of the population exposure risk index; Oᵢ represents a population density of an i-th urban region, with a unit being a person per km², and Rᵢ represents a building density of the i-th urban region, expressed as a percentage of the area occupied by the buildings.

The population exposure risk index is used to assess the population density and risk in the ultra-low altitude airspace, and to adjust the capacity calculation.

The calculation of a building impact factor is as follows:

$$B = {Σ}_{s = 1}^{S} ( \frac{{H}_{s}}{{H}_{max}} \cdot \frac{{AL}_{s}}{{AL}_{t}} ) ;$$

where B represents the building impact factor; S represents a number of buildings in the urban regions, with s ranging from 1 to S; Hₛ represents a height of an s-th building in the urban regions; Hₘₐₓ represents a height of the tallest building in the urban regions; ALₛ represents a ground area occupied by the s-th building in the urban regions; ALₜ represents a calculated ground area of the urban regions.

The step 3 considers the interference of the airspace by the height and distribution of the urban buildings.

Step 4: micro-meteorological data and communication signal data are acquired from the urban building information data to calculate an average signal strength, a signal propagation path length, and a micro-scale meteorological impact factor.

The calculation of the average signal strength in the airspace is based on the obtained communication signal data is as follows:

$${RSSI}_{a} = \frac{{Σ}_{i = 1}^{n} {RSSI}_{i}}{n} ;$$

where RSSIₐ represents the average signal strength of the airspace, taking an absolute value thereof; RSSIᵢ represents a signal strength of the i-th sub-airspace.

The calculation of the signal propagation path length is as follows:

$${D}_{al} = \frac{1}{n \cdot m} \times {Σ}_{i = 1}^{n} {Σ}_{j = 1}^{m} \sqrt{{( {p}_{i 1} - {R}_{xj} )}^{2} + {( {p}_{i 2} - {R}_{yj} )}^{2}} ;$$

where Dₐ₁ represents the signal propagation path length; m represents a number of signal transmission infrastructures in the airspace, with j ranging from 1 to m; Rₓⱼ represents a horizontal coordinate of a j-th signal transmission infrastructure, and R_{yj} represents a vertical coordinate of the j-th signal transmission infrastructure.

The calculation of the micro-scale meteorological impact factor is based on the obtained micro-meteorological data:

$$M = {\sum }_{i = 1}^{n} ( \frac{{v}_{w , i}}{{v}_{w , s}} \cdot \frac{{T}_{i}}{{T}_{s}} \cdot \frac{{H}_{i}}{{H}_{s}} ) ;$$

where M represents the micro-scale meteorological impact factor; V_{w,i} represents an average wind speed of the i-th sub-airspace; V_{w,s} represents a maximum withstanding wind speed of an aircraft; Tᵢ represents an average temperature of the i-th sub-airspace; Tₛ represents an operational temperature of the aircraft; Hᵢ represents an average humidity of the i-th sub-airspace; Hₛ represents an operational humidity of the aircraft.

The step 4 considers the impact of meteorological factors such as wind speed, temperature, and humidity on the airspace.

Step 5: an airspace model is used to calculate the urban ultra-low altitude airspace capacity based on the fundamental airspace capacity, the population exposure risk index, the building impact factor, the average signal strength, the signal propagation path length, and the micro-scale meteorological impact factor.

The comprehensive calculation of the urban ultra-low altitude airspace capacity is as follows:

$${C}_{e} = {C}_{b} \times ( 1 - \frac{PERI}{{PERI}_{max}} ) \times ( \frac{{W}_{1} \cdot \vert {RSSI}_{a} \vert}{{W}_{2} \cdot {D}_{al}} ) \times ( \frac{1}{1 + β \cdot B} ) \times ( \frac{1}{1 + γ \cdot M} ) ;$$

where Cₑ represents the urban ultra-low altitude airspace capacity; W₁ represents a weight coefficient for the average signal strength of the airspace, and W₂ represents a weight coefficient for the signal propagation path length; β represents a building impact adjustment coefficient; γ represents the micro-scale meteorological impact adjustment coefficient.

In summary, the embodiment of the disclosure comprehensively considers the factors affecting the urban ultra-low altitude airspace capacity when calculating the ultra-low altitude airspace capacity, such as the population exposure risk index, the building impact factor, the average signal strength, the signal propagation path length, and the micro-scale meteorological impact factor. It scientifically integrates and normalizes each influencing factor into an efficient and rapid method, which is beneficial for a preliminary safe and fast assessment of the overall capacity of urban ultra-low altitude airspace before the planning of urban ultra-low altitude airspace infrastructure.

Step 6: Based on the urban ultra-low altitude airspace capacity calculated in Step 5, results of the urban ultra-low altitude airspace capacity are transmitted to an UAV control system to optimize flight paths and coordinate airspace utilization. Detailed steps are as follows.
1. Transmission and Parsing of Capacity Information: data of the urban ultra-low altitude airspace capacity calculated in Step 5 is transmitted to UAV controllers via a communication module. The UAV controllers include the following functional modules.
1.1 An airspace information parsing module, which is configured to parse the received data of the urban ultra-low altitude airspace capacity to generate a usable airspace map for a mission. The usable airspace map includes flyable areas, no-fly zones, and densely populated areas.
1.2 A task priority module, which is configured to allocate higher-capacity regions to tasks with higher priorities (e.g., emergency or logistics missions).
2. Path Planning and Optimization. Based on the data of the urban ultra-low altitude airspace capacity and mission requirements, the UAV control system uses path optimization algorithms (e.g., a Dijkstra algorithm, an A* algorithm, or a reinforcement learning) to dynamically plan takeoff/landing points and flight paths while considering:
avoiding the no-fly zones and the high-population-density areas to reduce safety risks.
optimizing path length to minimize energy consumption and flight time.
ensuring stable communication signals along the flight path and avoiding signal-blocked regions.
adapting flight altitude and direction to micro-meteorological conditions (e.g., wind speed and humidity).
3. Mission Assignment and Scheduling. An UAV dispatch plan is dynamically adjusted based on the urban ultra-low altitude airspace capacity, including:
allocating the UAVs to takeoff/landing points and prioritizing tasks dynamically.
adjusting takeoff/landing times to ensure the number of the UAVs in operation does not exceed the airspace capacity.
optimizing multi-UAV fleet coordination to maintain safe distances between the UAVs for collaborative missions.
4. Feedback and Real-Time Monitoring. During the mission, the UAVs provide real-time feedback on flight status and airspace occupancy to the ground control center via the communication module. The control center dynamically updates the urban ultra-low altitude airspace capacity based on real-time data and, if necessary, replans flight paths or adjusts task assignments.

It should be noted that the execution order of the steps 2, 3, and 4 is not limited to this sequence and can be interchanged. For example, the execution order could be step 2, step 4, step 3, or step 3, step 2, step 4, or step 4, step 2, step 3, etc.

The above description is merely a specific embodiment of the disclosure, but the scope of protection of the disclosure is not limited thereto. Any those skilled in the art familiar with the technical field can easily think of variations or substitutions within the technical scope of the disclosure, and all should be covered within the scope of protection of the disclosure. Therefore, the scope of protection of the disclosure should be determined by the scope of the claims.

What is claimed is:

1. A method for urban ultra-low altitude airspace division and capacity calculation, comprising:
step 1: using an improved Voronoi method to divide airspace; wherein the step 1 comprises:
improving a Voronoi method by adding dynamic balance weights thereto obtain the improved Voronoi method:
$$P = \{ {p}_{1} , {p}_{2} , … , {p}_{n} \} ;$$
$$W = \{ {w}_{1} , {w}_{2} , … , {w}_{n} \} ;$$
where n represents a number of sub-airspaces after the dividing, and there is only one takeoff and landing point in each of the sub-airspaces; P represents a set of the takeoff and landing points of the respective sub-airspaces, pᵢ represents an i-th takeoff and landing point; W represents a set of initial weights, wᵢ represents an initial weight of the i-th takeoff and landing point, and wᵢ=1, i=1, 2, . . . , n;
$${d}_{w} ( x , {p}_{i} ) = \sqrt{{( {x}_{1} - {p}_{i 1} )}^{2} + {( {x}_{2} - {p}_{i 2} )}^{2}} - {w}_{i} ;$$
where d_{w}(x, pᵢ) represents a weighted distance;
for any point x within the airspace, finding pᵢ minimizing d_{w}(x, pᵢ) to assign x to V(pᵢ),
where V(pᵢ) represents an i-th sub-airspace where pᵢ is located; x₁ represents a horizontal coordinate of the point x, and x₂ represents a vertical coordinate of the point x; pᵢ₁ represents a horizontal coordinate of the takeoff and landing point pᵢ, and pᵢ₂ represents a vertical coordinate of the takeoff and landing point pᵢ;
$${A}_{i} = \int {V ( {p}_{i} )}^{d A} ;$$
$$\overline{A} = \frac{1}{n} {\sum }_{i = 1}^{n} {A}_{i} ;$$
$${f}_{i} = \frac{{A}_{i}}{\overline{A}} ;$$
$${W}_{i} ← {w}_{i} \cdot {f}_{i} ;$$
where A represents a total area of the airspace; Aᵢ represents an area of the i-th sub-airspace; and
$$\overline{A}$$
represents an average area of the sub-airspaces; fᵢ represents a dynamic balance factor of the i-th sub-airspace; wᵢ←wᵢ·fᵢ represents fᵢ approaching 1 after several iterations;
step 2: calculating a fundamental airspace capacity;
step 3: acquiring urban building information data, calculating a population exposure risk index and a building impact factor;
step 4: acquiring micro-meteorological data and communication signal data of urban buildings, calculating an average signal strength, a signal propagation path length, and a micro-scale meteorological impact factor;
step 5: using an airspace model to calculate the urban ultra-low altitude airspace capacity based on the fundamental airspace capacity, the population exposure risk index, the building impact factor, the average signal strength, the signal propagation path length, and the micro-scale meteorological impact factor.

2. The method for urban ultra-low altitude airspace division and capacity calculation as claimed in claim 1, wherein the step 2 comprises:
calculating the fundamental airspace capacity as follows:
$${C}_{b} = ( A - {A}_{nf} ) \cdot T \cdot μ ;$$
where C_{b} represents the fundamental airspace capacity; A_{nf} represents an area of a no-fly zone; T represents a time period; u represents a service rate;
$$μ = \frac{{n}^{2} ( {F}_{d m} + {F}_{d 1} + {F}_{d s} )}{{\sum }_{i = 1}^{n} {D}_{a i}} ;$$
where F_{dm} represents a takeoff and landing frequency of a micro unmanned aerial vehicle (UAV); F_{dl} represents a takeoff and landing frequency of a light UAV; F_{ds} represents a takeoff and landing frequency of a small UAV; Dₐᵢ represents an average distance from the i-th takeoff and landing point pᵢ to boundary vertices of the i-th sub-airspace of pᵢ;
$${D}_{a i} = \frac{1}{K} {\sum }_{k = 1}^{K} \sqrt{{( {x}_{k} - {p}_{i 1} )}^{2} + {( {y}_{k} - {p}_{i 2} )}^{2}} ;$$
where K represents a number of the boundary vertices of the i-th sub-airspace, with k ranging from 1 to K; xₖ represents a horizontal coordinate of a k-th boundary vertex, and yₖ represents a vertical coordinate of the k-th boundary vertex.

3. The method for urban ultra-low altitude airspace division and capacity calculation as claimed in claim 2, wherein in the step 3, the calculating a population exposure risk index comprises:
$$PERI = \frac{1}{n} {\sum }_{i = I}^{n} {O}_{i} \cdot {R}_{i}$$
$$PER {I}_{max} = max \{ {O}_{1} \cdot {R}_{1} , {O}_{2} \cdot {R}_{2} … , {O}_{n} \cdot {R}_{n} \} ;$$
where divided urban regions are corresponding to the divided sub-airspaces of the airspace; PERI represents the population exposure risk index, and PERIₘₐₓ represents a maximum value of the population exposure risk index; Oᵢ represents a population density of an i-th urban region, and Rᵢ represents a building density of the i-th urban region, with i=1, . . . , n.

4. The method for urban ultra-low altitude airspace division and capacity calculation as claimed in claim 3, wherein in the step 3, the calculating a building impact factor comprises:
$$B = {\sum }_{s = 1}^{S} ( \frac{{H}_{s}}{{H}_{max}} \cdot \frac{{AL}_{s}}{{AL}_{t}} ) ;$$
where B represents the building impact factor; S represents a number of buildings in the urban regions, with s ranging from 1 to S; H represents a height of an s-th building in the urban regions; Hₘₐₓ represents a height of the tallest building in the urban regions; ALₛ represents a ground area occupied by the s-th building in the urban regions; ALₜ represents a calculated ground area of the urban regions.

5. The method for urban ultra-low altitude airspace division and capacity calculation as claimed in claim 4, wherein in the step 4, the calculating an average signal strength comprises:
calculating an average signal strength of the airspace as follows:
$${RSSI}_{a} = \frac{{\sum }_{i = I}^{n} RSS {I}_{i}}{n} ;$$
where RSSIₐ represents the average signal strength of the airspace, taking an absolute value thereof; RSSIᵢ represents a signal strength of the i-th sub-airspace.

6. The method for urban ultra-low altitude airspace division and capacity calculation as claimed in claim 5, wherein in the step 4, the calculating a signal propagation path length comprises:
calculating the signal propagation path length as follows:
$${D}_{al} = \frac{1}{n \cdot m} \times {\sum }_{i = 1}^{n} {\sum }_{j = 1}^{m} \sqrt{{( {p}_{i 1} - {R}_{x j} )}^{2} + {( {p}_{i 2} - {R}_{y j} )}^{2}} ;$$
where Dₐ₁ represents the signal propagation path length; m represents a number of signal transmission infrastructures in the airspace, with j ranging from 1 to m; Rₓⱼ represents a horizontal coordinate of a j-th signal transmission infrastructure, and R_{yj} represents a vertical coordinate of the j-th signal transmission infrastructure.

7. The method for urban ultra-low altitude airspace division and capacity calculation as claimed in claim 6, wherein in the step 4, the calculating a micro-scale meteorological impact factor comprises:
calculating the micro-scale meteorological impact factor as follows:
$$M = {\sum }_{i = 1}^{n} ( \frac{{v}_{w , i}}{{v}_{w , s}} \cdot \frac{{T}_{i}}{{T}_{s}} \cdot \frac{{H}_{i}}{{H}_{s}} ) ;$$
where M represents the micro-scale meteorological impact factor; V_{w,i} represents an average wind speed of the i-th sub-airspace; V_{w,s} represents a maximum withstanding wind speed of an aircraft; Tᵢ represents an average temperature of the i-th sub-airspace; Tₛ represents an operational temperature of the aircraft; Hᵢ represents an average humidity of the i-th sub-airspace; Hₛ represents an operational humidity of the aircraft.

8. The method for urban ultra-low altitude airspace division and capacity calculation as claimed in claim 6, wherein the step of using an airspace model to calculate the urban ultra-low altitude airspace capacity based on the fundamental airspace capacity, the population exposure risk index, the building impact factor, the average signal strength, the signal propagation path length, and the micro-scale meteorological impact factor comprises:
comprehensively calculating the urban ultra-low altitude airspace capacity as follows:
$${C}_{e} = {C}_{b} \times ( 1 - \frac{P E R I}{P E R {I}_{max}} ) \times ( \frac{{W}_{1} \cdot \vert RSS {I}_{a} \vert}{{W}_{2} \cdot {D}_{al}} ) \times ( \frac{1}{1 + β \cdot B} ) \times ( \frac{1}{1 + γ \cdot M} ) ;$$
where Cₑ represents the urban ultra-low altitude airspace capacity; W₁ represents a weight coefficient for the average signal strength of the airspace, and W₂ represents a weight coefficient for the signal propagation path length; β represents a building impact adjustment coefficient; γ represents the micro-scale meteorological impact adjustment coefficient.
